(19) United States
(12) Patent Application Publication
(10) Pub. No.: US 2026/0165900 A1
(43) Pub. Date: Jun. 18, 2026

(54) ACTIVE PELVIC ORTHOSIS INCLUDING A PHYSICAL HUMAN-ROBOT INTERFACE

(71) Applicant: IUVO S.R.L, Pontedera (PI) (IT)

(72) Inventors: Matteo MOISE, Pontedera (PI) (IT); Giacomo GIUSFREDI, Pontedera (PI) (IT); Marco MUSCOLO, Pontedera (PI) (IT); Lorenzo SACCARES, Pontedera (PI) (IT); Francesco GIOVACCHINI, Pontedera (PI) (IT); Roberto CONTI, Pontedera (PI) (IT); Giulia BIGONI, Pontedera (PI) (IT)

(21) Appl. No.: 19/125,824

(22) PCT Filed: Nov. 2, 2023
(86) PCT No.: PCT/IB2023/061072

§ 371 Date: Apr. 30, 2025

Related U.S. Application Data
(60) Provisional application No. 63/421,860, filed on Nov. 2, 2022.

(51) Int. Cl. A61H 3/00; A61H 1/02

(52) U.S. Cl. CPC A61H 3/00; A61H 1/0244; A61H 2003/007; A61H 2201/0192; A61H 2201/1616; A61H 2201/163; A61H 2201/1642; A61H 2201/1652; A61H 2201/5007

(57) ABSTRACT

An active pelvic orthosis (APO) has a physical Human-Robot interface (pHRi) adapted to adjust at different attachment points to accommodate a user's anthropometry to provide better torque about the hip flexion-extension joint during ambulation activities. The hip flexion-adjustment system is marked by at least four adjustment mechanisms, providing a means to better align the APO to a user's hip flexion-extension axis and maximize the stability and comfort of the pHRi of the APO.

### CROSS-REFERENCE TO RELATED DISCLOSURES

This application incorporates by reference U.S. Provisional Application No. 63/421,862, filed on Nov. 2, 2022. Likewise, the application incorporates by reference PCT Application No. PCT/IB 2023/061070, filed on Nov. 2, 2023, by the same applicant and assignee of this disclosure.

### FIELD OF THE DISCLOSURE

The disclosure relates to an active pelvic orthosis (APO) having a physical Human-Robot interface (pHRi) adapted to adjust at different attachment points to accommodate a user's anthropometry to provide better torque about the hip flexion-extension joint during ambulation activities.

### BACKGROUND

Robot aids or exoskeletons are becoming useful tools for addressing needs in healthcare and industrial applications. These devices are arranged to generate and transfer mechanical power to human joints. These devices must achieve optimal kinematic coupling and compatibility between the human joints and rotation axes of the exoskeleton. An active exoskeleton typically has mechatronic designs, control systems, and human-machine interfaces arranged differently according to the expected usage.

Due to the intimate interaction with the body of the user, safety and ergonomics are critical features that heavily influence the functionality and dependability of an active exoskeleton. For example, a common problem with exoskeletons is a misalignment between the human and robot joints, which may lead to undesired forces being exerted on the human joints, resulting in discomfort or injury. In addition, these undesired forces may cause misapplication of forces on the human limb resulting in unreliable torque transmission and chaffing from shells or other means for securing against the human limbs, inefficient movement, and poor compliance.

It is difficult to consistently align the human joints with the robot joints, partly because of the variability among individual human anatomies. Another reason is that even if the human and robot joints are properly aligned, the human joints do not perfectly rotate because the users'geometries are not consistent and are complex, fluctuating over a range of motion.

An example of a robotic aid is a hip joint exoskeleton, hereafter referred to as an active pelvis orthosis (APO), which is a wearable exoskeleton arranged to improve gait energy efficiency, especially as affected by impairments of the hip. The APO may be of the type described in WO 2019/211791, published Nov. 7, 2019, or such as an APO arranged to smoothly provide torque about the hip flexion-extension joint during walking or similar activities. The APO includes a physical Human-Robot interface (pHRi) to ensure comfort despite activation by the control or actuation system of the user's joints by the exoskeleton. The APO can be used in rehabilitation programs for disabled or injured persons, assisting chronically disabled patients, or training protocols for a healthy subject, regardless of age.

There are a variety of possible iterations of an APO. For example, the APO may be adapted to interface with a treadmill, physical diagnostic tool, or device in a rehabilitation or training setting. In addition, different types of assistive or actuation units may be employed i.e., assistive pairs of flexion-extension actuators or actuation systems may be provided, at one or both hips of the user. These actuation units may be passive because a passive joint mechanism with a series of linkages and/or springs is used, or active actuation units that are powered or controlled by mechatronics. If powered or electronically controlled actuation units are powered, they may be battery-operated or tethered to a power source.

The anthropometry of users can range widely. Proper mechanical power transfer requires optimal tuning of the kinematic coupling between the robotic and anatomical joint rotation axes. It can be challenging to maintain the stability of the APO while worn to avoid slippage and to enhance comfort. Further complicating matters is that the APO must be able to efficiently transfer the assistance offered by the APO to the user's body while maintaining such comfort and avoiding injury to the user, particularly when the APO is worn for a sustained time.

As a consequence of different anthropometries, settings for APOs (clinic or daily use), and types of APOs (i.e., passive or active), the relative positions/distances and shapes of the different attachment points of the pHRi that characterize the APO should be able to change accordingly. Likewise, it is desired to offer such adjustability without modifying the operation of the APO, particularly assistive units, whether passive or active, and any corresponding mechatronics.

Therefore, there is a need for a pHRi in an APO that overcomes these problems in existing devices without compromising the effectiveness of transmission of forces from the robot joints.

### SUMMARY

The disclosure relates to a powered hip orthosis (Active Pelvic Orthosis, APO) arranged to smoothly provide torque to the hip flexion-extension joint during walking or similar activities. The APO is a bilateral powered exoskeleton and includes three main subsystems: the mechanical structure, the actuation units, and the control system. Considering the mechanical structure, this structure involves the interface for transferring torque provided by the actuation units and controlled by the control system. It is upon the mechanical structure or the physical Human-Robot interface (pHRi) that the disclosure is focused on.

The disclosed pHRi is arranged to embrace the user at (i) the thighs, (ii) the trunk, and (iii) the shoulders using a belt system and/or a shoulder strap system. The proposed pHRi is arranged to maximize the stability of the APO when worn by the user, avoiding slippages and enhancing comfort. The pHRi is arranged to be stable on the user to transfer efficiently the assistance generated by the APO to the user's body. The pHRi needs to be comfortable so as to not to injure the user's skin while forces are transferred by the APO to the user and vice versa, especially if the device wants to be used continually for long periods. In parallel, the pHRi of the APO is arranged to minimize its weight and number and the dimensions of its attachment points.

The pHRi includes the following features: shoulder strap system, belt system, thigh link assembly, and a plurality of adjustment mechanisms (collectively referred to as “hip flexion-adjustment system”) to transfer the assistive torque generated by the APO to the thigh link assembly.

The shoulder strap system is removably attached to the belt system and preferably comprises straps arranged to extend around a user's shoulders. The shoulder strap system has anterior and posterior links configured to couple to anterior and posterior straps connected to the belt system.

The belt system defines a rigid structure that includes a posterior, central component and first and second lateral components extending from opposed sides of the central component. The belt system also defines first and second buckle parts that are arranged to couple to one another and flexibly extending from the first and second lateral components. In a preferred embodiment, the belt system includes a central pad configured to attach and correspond to the central component. Additionally, or alternatively, the first and second lateral component pads are configured to attach and correspond to the first and second lateral components.

The thigh link assembly is arranged to transfer the torque generated by the assistive units to the user's legs. The thigh link assembly includes a cuff to ensure an ergonomic and stable connection between the user's legs and thigh link segments, which are connected by the hinge mentioned above so they can rotate freely relative to one another. Such a hinge enables a passive degree of freedom to passively account for a different user's leg shape and a user's lateral pelvic tilt movements. Other implementations may be provided to reduce weight, friction, different sliding arrangements among parts, and other modifications to achieve better fit and comfort.

The hip flexion-adjustment system is marked by at least four adjustment mechanisms, providing a means to better align the APO to a user's hip flexion-extension axis and maximize the stability and comfort of the pHRi of the APO. Furthermore, to maximize its wearability and minimize its encumbrance, the hip flexion-adjustment system is configured with such hip flexion-adjustment system to account for different user's anthropometry.

In particular, the combination of the at least four adjustment mechanisms allows accounting for different user abdominal/lumbar region sizes and different user heights. While at least four adjustment mechanisms are described, including variations thereof, they need not be provided all in combination. It is well within the scope of the disclosure to include only or a single instance of one or at least one of any number of the described adjustment mechanisms, either alone in or in combination with one another.

The first adjustment mechanism includes regulating the position of the assistive unit along the human lateral axis. It passively follows the orientation of the assistive unit, imposed by the third adjustment mechanism, on a plane parallel to the human sagittal plane. Likewise, the first adjustment mechanism may comprise a revolute joint relative to the lumbar region of the APO carrying the electronic or control system enclosed by an enclosure.

A connection element links the backpack enclosure to the assistive unit, so the first end of the connection element may lock against the backpack enclosure or frame. When the connection element is unlocked relative to the backpack enclosure, the connection can slide inward and outward relative to the backpack enclosure and may likewise rotate relative thereto. The connection element may be structurally configured in an L-shape or have a generally perpendicular bend between the first and second ends of the connection element, such that the bend is in the range of 75 to 100 degrees to reorient the assistive device relative to the backpack enclosure.

The second adjustment mechanism may be located on the assistive unit. It may comprise a locking feature of a second end of the connection element to the covering or frame of the assistive unit. From a schematic point of view, it can be represented by a prismatic joint. Along the connection element, the second adjustment mechanism is arranged to regulate the relative distance between the rotation axis of the first adjustment mechanism and the assistive unit axis on the human sagittal plane.

The third adjustment mechanism connects the assistive unit to the belt system with a regulatable strut. On the Assistive unit, the strut is attached on its axis, while the strut is fixed to the belt at a point corresponding to a user's iliac crest. The third adjustment mechanism regulates the distance between the belt system and the assistive unit axis on a plane parallel to the human sagittal plane. The third adjustment mechanism permits rotation of the assistive unit about the first assistive unit axis or relative to the backpack enclosure.

The fourth adjustment mechanism is arranged to account for a different user's leg shape passively and a user's lateral pelvic tilt movements. The fourth adjustment mechanism involves the thigh link assembly pivotally secured to the assistive unit about an assistive unit rotational axis to form a revolute joint. The thigh link assembly includes a hinge between the first and second thigh links.

As mentioned above, the APO and the pHRi may be provided with any combination of the aforementioned four adjustment mechanisms and sub-assemblies. Moreover, the pHRi may be modified with or without various components, such as the shoulder strap system or the belt system. Such systems may likewise be modified to better accommodate an individual user's anatomy.

These and other features, aspects, and advantages of the present disclosure will help better understand the following description, appended claims, and accompanying drawings.

### BRIEF DESCRIPTION OF THE DRAWINGS

FIG. 1 is a diagram showing planes and axes of movement.

FIG. 2 is a perspective view of an Active Pelvic Orthosis (APO) supported by a physical Human-Robot interface (pHRi).

FIG. 3 is a frontal or anterior perspective view of a shoulder strap system forming part of the pHRi in FIG. 2.

FIG. 4 is a rear or posterior perspective view of the shoulder strap system of FIG. 3.

FIG. 5 is a schematic view of a belt system forming part of the pHRi in FIG. 2.

FIG. 6 is a schematic view of a variation of the belt system in FIG. 5.

FIG. 7 is a schematic perspective view showing the APO and the four adjustment mechanisms.

FIG. 7A illustrates schematic perspective views showing first and second sides of the assistive units in the APO of FIG. 7.

FIG. 7B illustrates schematic perspective views of a variation of the assistive units of FIG. 7.

FIG. 8 is a schematic detail view of the first adjustment mechanism connecting the assistive unit to the backpack enclosure.

FIG. 9 is a schematic cross-sectional view of a portion of FIG. 8.

FIG. 10 is a schematic cross-section view of a variation of the first adjustment mechanism.

FIG. 11 is a schematic perspective view of another variation of the first adjustment mechanism.

FIG. 12 is a detailed view of the first adjustment mechanism of FIG. 11.

FIG. 13 is a schematic view of the second adjustment mechanism.

FIG. 14 is a cross-sectional view of the assistive unit and the second adjustment mechanism of FIG. 13.

FIG. 15A is a perspective view of the third adjustment mechanism.

FIG. 15B is a schematic view of a kinematic chain of the third adjustment mechanism of FIG. 15A.

FIG. 16 is a schematic view of the third adjustment mechanism of FIG. 15A.

FIG. 17 is a schematic view showing lateral tilt relative to human anatomy.

FIG. 18 is a schematic view showing the fourth adjustment mechanism.

FIGS. 18A-18D are schematic views of a variation of a thigh link assembly of FIG. 18.

FIGS. 18E-18H are schematic views of another variation of the thigh link assembly of FIG. 18.

FIGS. 18I-18K is a schematic view showing a thigh extension strut having a length adjustment mechanism.

FIG. 19 is a schematic view of another adjustment mechanism.

The drawing figures are not necessarily drawn to scale. Instead, they are drawn to provide a better understanding of the components and are not intended to be limiting in scope but providing exemplary illustrations.

### DETAILED DESCRIPTION OF VARIOUS EMBODIMENTS

### A. Overview

A better understanding of different embodiments of the disclosure may be had from the following description read with the accompanying drawings in which reference characters refer to like elements. While the disclosure is susceptible to various modifications and alternative constructions, certain illustrative embodiments are in the drawings and are described below. It should be understood, however, that there is no intention to limit the disclosure to the embodiments disclosed; on the contrary, the intention covers all modifications, alternative constructions, combinations, and equivalents falling within the spirit and scope of the disclosure.

A better understanding of different embodiments of the disclosure may be had from the following description and accompanying drawings in which reference characters refer to like elements.

It will be understood that unless a term is defined to possess a described meaning, there is no intent to limit the meaning of such term, either expressly or indirectly, beyond its plain or ordinary meaning.

### B. Definitions

For ease of understanding, the disclosed embodiments of an exoskeleton and components for use therewith, the interior and exterior portions of the exoskeleton may be described independently. The Interior and exterior portions of the exoskeleton function together to support a user in exerting efforts.

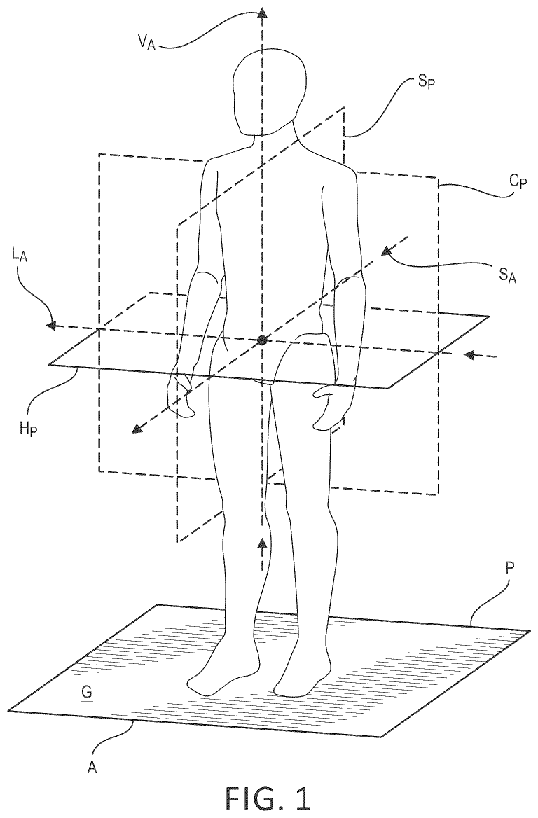

FIG. 1 exemplifies various planes and axes of movement used to identify the relative positions of body parts or relationships between those parts.

For further ease of understanding the embodiments of an orthopedic device as disclosed, a description of a few terms, when used, is necessary. As used, the term “proximal” has its ordinary meaning and refers to a location next to or near the point of attachment or origin or a central point located toward the center of the body. Likewise, the term “distal” has its ordinary meaning and refers to a location situated away from the point of attachment or origin or a central point or located away from the center of the body.

Medial is toward the body's midline or the median or sagittal plane (SP), which splits the body head-to-toe into two halves, the left and right. Lateral is the side or part of the body that is away from the middle. For example, for a leg, the medial side is on the inside of the exoskeleton, and the lateral side is on the outside of the device relative to the median plane.

The coronal or frontal plane (CP) divides the body into posterior (P) and anterior parts (A), and is perpendicular to the sagittal plane (SP). The term “posterior” also has its ordinary meaning and refers to a location behind or at another location's rear. The term “anterior” has its ordinary meaning and refers to a location ahead of or in front of another location.

The transverse or horizontal plane (HP) divides the body into superior and inferior parts and may be considered relative to the ground (G).

Therefore, the term “frontal plane” has its ordinary meaning and refers to a plane extending through a body to divide the body into the front or anterior and back or posterior halves. The term “sagittal plane” has its ordinary meaning and refers to a plane extending through a body to divide the body into left and right halves, as in the mid-sagittal plane referenced above. The term “transverse plane” has its ordinary meaning and refers to a plane extending through a body to divide the body into the top or upper and bottom or lower halves.

Movement at the joints takes place in a plane about an axis, and there are three axes of rotation, including the sagittal axis (SA), the lateral axis (LA), and the vertical axis (VA). The sagittal axis passes horizontally from posterior to anterior and is formed by the intersection of the sagittal and transverse planes. The lateral axis passes horizontally from left to right and is formed by the intersection of the frontal and transverse planes. The vertical axis passes vertically from inferior to superior and is formed by the intersection of the sagittal and frontal planes.

Flexion and extension are movements that occur in the sagittal plane. They refer to increasing and decreasing the angle between two body parts: flexion refers to a movement that decreases the angle between two body parts. Extension refers to a movement that increases the angle between two body parts. Abduction is a movement away from the midline—just as abducting someone is to take them away. Adduction is a movement toward the midline.

The terms “rigid” and “flexible” are repeatedly used herein to distinguish characteristics of portions of the APO and pHRi. The term “rigid” is intended to denote that the structural element or frame is generally devoid of flexibility. Within the context of elements that are “rigid,” it is intended to indicate that they may break if bent with sufficient force. On the other hand, the term “flexible” is intended to denote that features are capable of repeated bending. The term “resilient” is used to qualify such flexible features as generally returning to the initially molded shape with permanent deformation.

The term “assistive unit,” “actuator,” or “actuation unit” refers to a mechanical or electro-mechanical device adapted to provide controlled and sometimes limited movements or positioning of a limb or body, the device being operated passively (i.e., springs, weight redistribution, energy capture, dampening, locking), electrically (i.e., DC motor, series elastic actuation, brushless, induction, variable stiffness actuation, torque motor, linear motor, stepper), pneumatically (pneumatic artificial muscle, soft-actuation), or by various fluids such as air, hydraulic, etc.

The term “control system” is used to describe a main circuit board that is configured to provide power and a suitable electronic interface for the wired connections of the APO, particularly for the actuator or assistive unit. In an embodiment, the control system is a microcontroller or a circuit that is configured to generate control commands on the basis of, e.g., sensor, signals, wherein the control commands control the state or the behavior of the APO or assistive unit. If powered or electronically controlled actuation units are employed to power the APO, the control system may comprise a power source (e.g., battery) within the backpack enclosure or be tethered to an external power source. Preferably, the power source is arranged to provide auxiliary power to the actuation units to drive the at least one thigh link assembly.

The term “physical Human-Robot interface” (pHRi) refers to a mechanical structure, or harness, arranged to embrace the user at the thighs, trunk, and shoulders or a wearer using a belt system and/or a shoulder strap system.

C. Various Embodiments of the Active Pelvic Orthosis (APO) and the Physical Human-Robot Interface (pHRi)

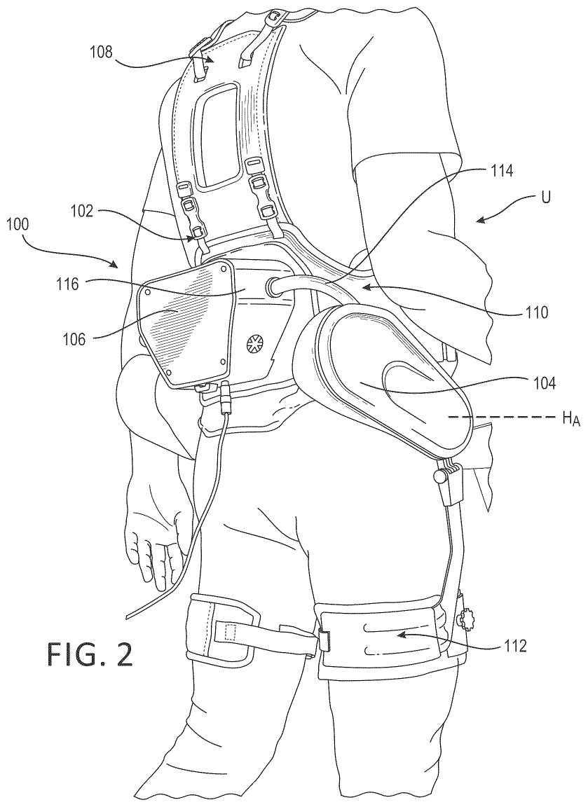

FIG. 2 depicts an embodiment of an APO 100 arranged to smoothly provide torque to the hip flexion-extension joint during walking or similar activities. The APO 100 is a bilateral powered exoskeleton, and includes three main subsystems: the pHRi 102, the assistive units 104, and the control system 106. In considering the pHRi 102, this structure involves the interface for transferring torque provided by the assistive units 104 and controlled by the control system 106.

The assistive unit 104 is configured for being provided on the left and right sides of the user, and provides torque to the user's hip flexion-extension motion about a user's hip flexion-extension axis HA. The control system 106 includes electronics, an energy supply or connection thereto, and a backpack enclosure 116 for containing such components. The assistive unit 104 is adjustably connected to a belt system 110 of the pHRi 102 and the control system 106 by a coupling assembly 114. The coupling assembly 114 is arranged to rotatably adjust or linearly adjust the assistive unit 104 relative to the belt system 110. In an embodiment, the coupling assembly 114 is a structural pipe (e.g., aluminum pipe) or rod to couple the assistive unit 104 to the backpack enclosure 116.

In the following discussion, while the APO is bilateral, typically, only one side (i.e., left or right corresponding to a user) will be referred to or represented for the sake of simplicity.

The pHRi 102 is arranged to make the APO 100 wearable by a user. The pHRi is configured to embrace the user at (i) the thighs, (ii) the trunk, and (iii) the shoulders using a belt system and/or a shoulder strap system. The pHRi is arranged to maximize the stability of the APO when worn by the user, avoiding slippages and enhancing comfort. The pHRi is arranged to be stable on the user to transfer efficiently the assistance generated by the APO to the user's body. The pHRi needs to be comfortable not to injure the user's skin while forces are transferred by the APO to the user and vice versa, especially if the device wants to be used continually for long periods. In parallel, the pHRi of the APO is arranged to minimize its weight, number, and the dimensions of its attachment points.

The pHRi 102 includes a belt system 110 arranged to circumferentially extend about a waist or trunk user, and position the assistive units appropriately to facilitate hip extension and flexion. A thigh link assembly 112 is adjustably secured to the assistive unit 104, and the belt system 110. The thigh link assembly 112 is adapted to secure to a user's hip. The pHRi may also include a shoulder strap system 108 removably securable to the belt system 110. The control system 106 is carried at a lumbar region of the belt system 110, the enclosure to the control system 106 is referred to as a “backpack” enclosure 116.

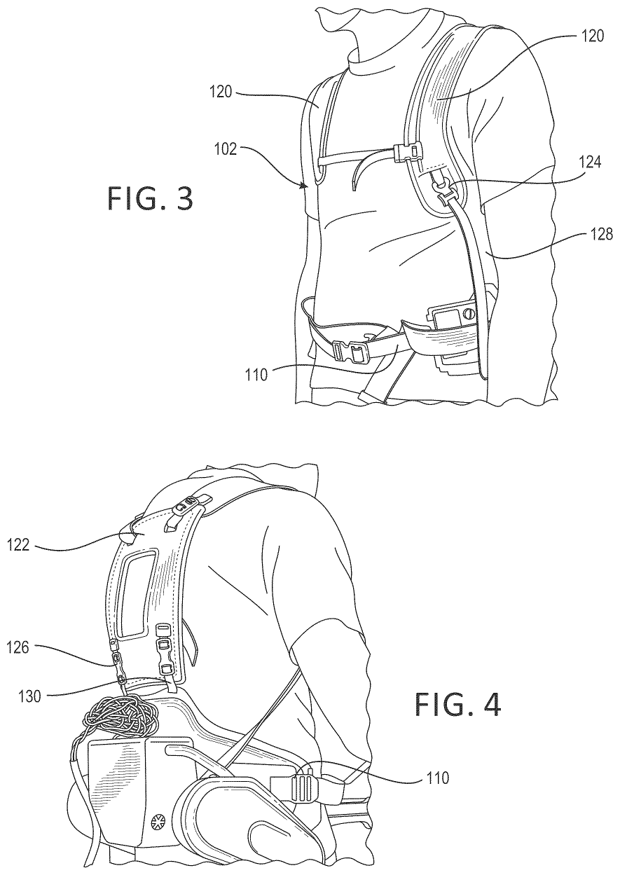

FIGS. 3 and 4 illustrate an embodiment of the shoulder strap system 108. The shoulder strap system 108 includes straps 120 and a back unit 122 arranged to be selectively attached to the belt system 110 by anterior and posterior links or buckles 124, 126 to anterior and posterior straps 128, 130 extending from the belt system 110. The links 124, 126 are defined as fasteners, i.e., buckles, snaps, press studs, hook and loop, D-rings, clasps, or buttons. Consequently, if needed, the shoulder strap system 108 can be removed from the belt system 110. It follows that the shoulder strap system 108 can be attached after the belt system 110 is donned, and the donning process of the APO is facilitated, especially for those who suffer from motor impairments at the level of the arms, arm spasticity, or flaccidity.

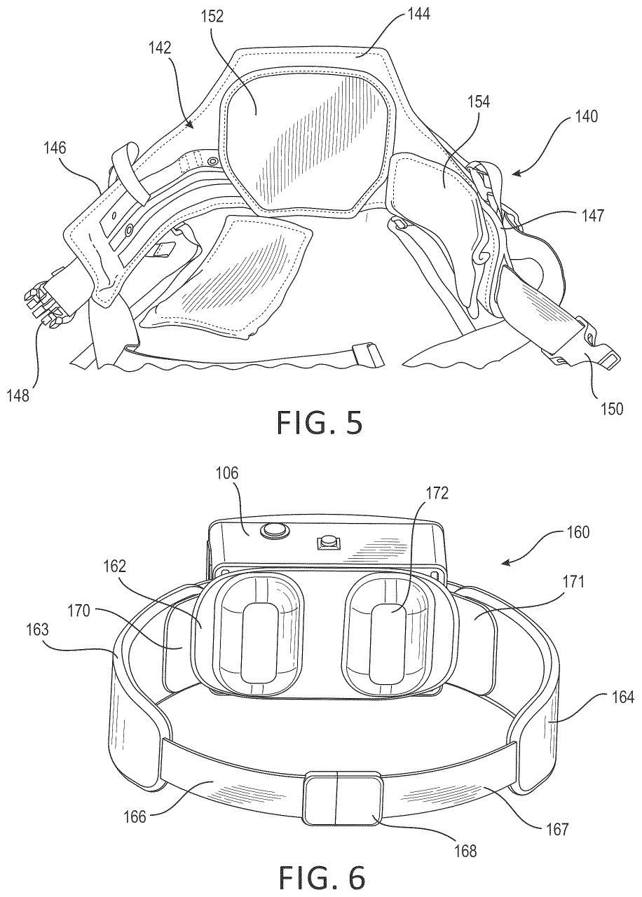

FIG. 5 depicts an embodiment of the belt system 140. The belt system 140 defines a frame or a rigid structure 142, including a posterior, central component 144, and first and second lateral components 146, 147 extending from opposed sides of the central component 144. The belt system 140 defines first and second coupling parts 148, 150 as arranged to couple to one another and flexibly extend from the first and second lateral components 146, 147. The belt system 140 further includes at least a central pad 152 configured to attach and correspond to the central component 144, and first and second lateral component pads 154 configured to attach and correspond to the first and second lateral components 146, 147, thereby permitting a tailored fit by way of padding to an individual user. While not shown, the belt system 140 may define slots on the rigid structure 142, that enable anchors on the straps to removably secure to the rigid belt (i.e., anchor and slot connection).

FIG. 6 illustrates another belt system embodiment 160. The belt system 160 defines a posterior, central component 162, and first and second lateral components 163, 164 connected by at least one connector 170, 171 selectively and/or removably attachable to the central component 162. The central component and the first and second lateral components 163, 164 are preferably rigid, and the at least one connector 170 is flexible and removably securable to the first and second lateral components 163, 164, by hook and loop fasteners, buttons, buckles, or other known removable fasteners. First and second flexible straps 166, 167 may extend from the first and second lateral components 163, 164, respectively, and couple to one another with coupling parts 168. The belt system 160 includes a pad 172 removably or permanently secured to the central component 162, which may be rigid. The pad may include structural features permitting improved air circulation and prevent excessive sweating, such as bumps, ridges, groove, or otherwise reticular structure, etc., as would be understood by one having ordinary skill in the art. For example, the pad may be formed from EVA (ethylene-vinyl acetate) or EPU 41 (i.e., polyurethan elastomer), which is a 3D printable production-scale material that is suited for elastomeric lattices where high resiliency is needed.

According to the embodiment of FIG. 6, the central component is rigidly fixed to the APO. In contrast, the side components are adjustable in position to account better for the different users'anthropometries. The position between the lateral and central components of the belt can be adjusted continuously with the connectors (e.g., hook and loop, fabric straps) or in a discrete manner (e.g., metal snap button).

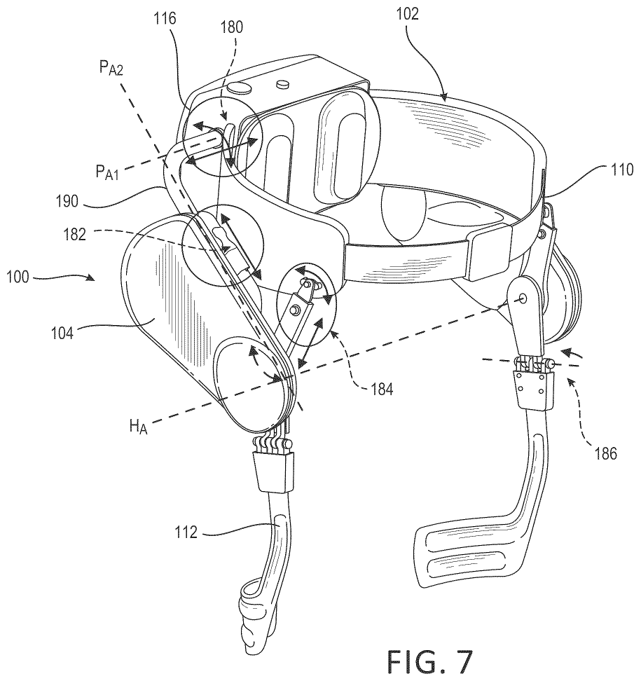

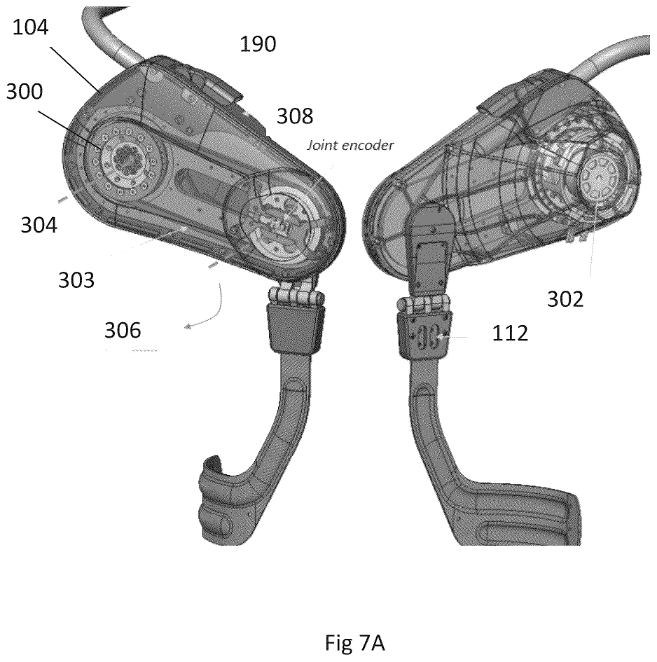

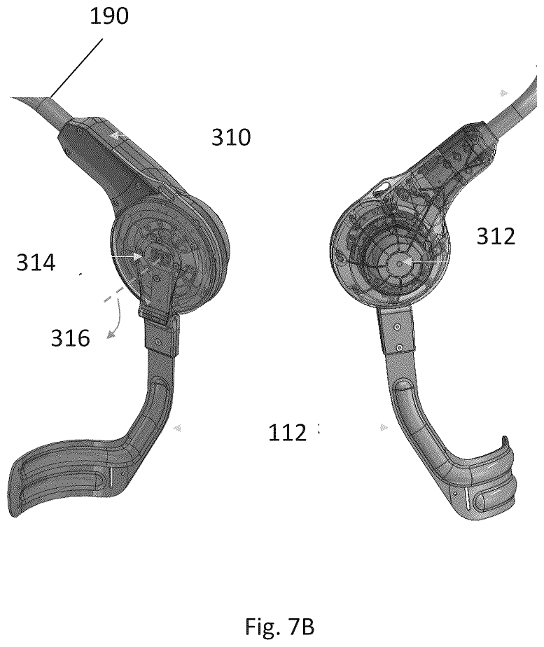

FIG. 7 depicts how the APO may be arranged with the pHRi that does not embrace the user at the shoulders. Trials have found that the APO can be stably and securely installed on a user with only the belt system, a thigh link assembly, and links to transfer the assistive torque generated by the APO to the thigh cuffs of the thigh link assembly.

Because the anthropometry can range widely among users, the relative positions/distances and shapes of the different attachment points of the pHRi that characterize powered hip orthoses should change accordingly. FIG. 7 illustrates an objective of the disclosure in providing adjustment mechanisms for donning and using the APO, particularly to align the assistive unit axis with the user's hip flexion-extension axis. The objectives can maximize the stability and the comfort of the pHRi of the APO.

To maximize its wearability and minimize its encumbrance, the APO 100 includes at least four adjustment mechanisms 180, 182, 184, 186 arranged to account for different user anthropometry. In particular, the combination of the adjustment mechanisms allows accounting for different user's abdominal/lumbar region sizes and for different user heights. While adjustment mechanisms are disclosure, to realize a lighter pHRi with lower manufacturing or assembly costs, the APO can be provided with locked features or only selectively have one or more of the adjustment mechanisms. While the adjustment mechanisms are numbered (i.e., first, second . . . ), they are numbered only to denote one from another, and such numbering does not indicate the priority or necessity of one over the other.

The first adjustment mechanism 180 includes regulating the position of the assistive unit 104 along the human lateral axis, and passively follows the orientation of the assistive unit 104, imposed by the third adjustment mechanism 184, on a plane parallel to the human sagittal plane SP. Likewise, the first adjustment mechanism 180 may comprise a revolute joint relative to the lumbar region of the APO carrying the electronic or control system enclosed by the backpack enclosure 116.

FIG. 7 depicts the coupling assembly as a connection element 190 links the backpack enclosure 116 to the assistive unit 104, such that a first end of the connection element may lock against the backpack enclosure 116 or a frame thereof. When the connection element 190 is unlocked relative to the backpack enclosure 116, the connection can slide inward and outward relative to the backpack enclosure and may likewise rotate relative thereto. The connection element 190 may be structurally configured in an L-shape or have a generally perpendicular bend between the first and second ends of the connection element, such that the bend is in the range of 75 to 100 degrees to reorient the assistive unit 104 relative to the backpack enclosure 116.

The second adjustment mechanism 182 may be located on the assistive unit 104, and may comprise a locking feature of a second end of the connection element to the covering or frame of the assistive unit. From a schematic point of view, it can be represented by a prismatic joint. Along the connection element 190, the second adjustment mechanism is arranged to regulate the relative distance between the rotation axis of the first adjustment mechanism 180 and the assistive unit 104 axis on the human sagittal plane.

The third adjustment mechanism 184 connects the assistive unit 104 to the belt system 110 with a regulatable strut. On the assistive unit, the strut is attached on its axis, while the strut is fixed to the belt at a point corresponding to a user's iliac crest. The third adjustment mechanism regulates the distance between the belt system 110 and the assistive unit axis on a plane parallel to the human sagittal plane. The third adjustment mechanism 184 permits rotation of the assistive unit 104 about the assistive unit axis or relative to the backpack enclosure 116.

The fourth adjustment mechanism 186 is arranged to account for a different user's leg shape passively, and a user's lateral pelvic tilt movements. The fourth adjustment mechanism 186 involves the thigh link assembly 112 pivotally secured to the assistive unit 104 about an assistive unit rotational axis to form a revolute joint. The thigh link assembly 112 includes a hinge between the first and second thigh links.

FIG. 7A illustrates simplified views of the assistive units in the APO of FIG. 7, having two rotation axes. Specifically, the assistive unit 104 includes an actuation unit 300 carried by the connection element 190. The actuation unit 300 includes an assistive unit input axis 304. A transmission unit 303 links the assistive unit input axis 304 to the assistive unit output axis 306, whereat a joint encoder 302 is located. A housing 308 connects the assistive unit 104 to the connection element 190 to the thigh link assembly 112. The actuation unit is found in U.S. Provisional Application No. 63/421,862, and PCT Application No. PCT/IB 2023/061070, and is incorporated herein by reference.

FIG. 7B illustrates a variation of assistive unit 310 having only one rotation axis. Specifically, the connection element 190 connects to the assistive unit 310 to the thigh link assembly 112. The assistive unit 310 includes an actuation unit 312 and an encoder 314 located an assistive unit rotation axis 316, thereby reducing the assistive unit about one rotational axis, and effectively removing the transmission unit in the embodiment of FIGS. 7A and 7B.

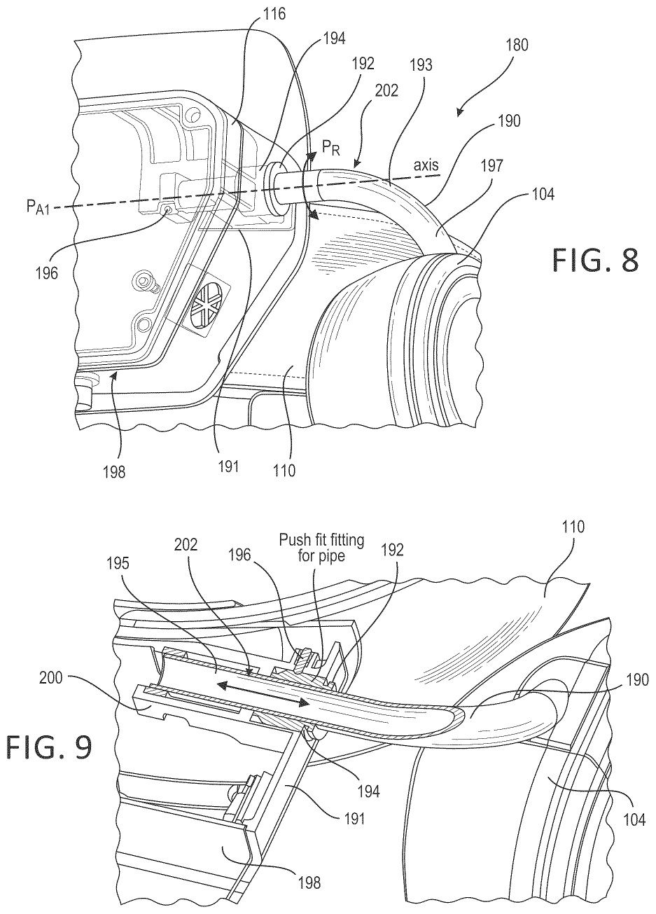

Referring to FIGS. 8 and 9, the first adjustment mechanism 180 is shown in greater detail. As shown in FIG. 2, backpack enclosure 116 is attached to the belt system 110, on its central rigid part, and to the assistive units through connection elements 190. The backpack enclosure 116 is composed of a frame 198, on which all the internal components of the control system 106 are attached. In particular, the backpack enclosure may contain the electronics of the control system, a width adjustment system, and a locking system for regulating the orientation of the assistive units.

The width adjustment system will be described according to its constituent components and is arranged to regulate the position of the assistive units along the connection element rotation axis parallel to the human lateral axis. While the connection element is configured as a pipe, it is not limited to the construction of a pipe but may be formed by other shapes. The first adjustment mechanism may include a push fit fitting for regulating the position of the connection element. Once the orientation of the assistive unit is selected through the third adjustment mechanism, the position of the connection element may be locked concerning the backpack enclosure. This arrangement allows correctly transferring the torque generated by the assistive unit to the user.

The connection element 190 has a generally perpendicular bend 193 between the first and second ends 195, 197 of the connection element 190. The bend 193 may be in the range of 75 to 105 degrees to reorient the assistive unit 104 relative to the backpack enclosure 116 arranged to correspond to a lumbar and posterior region on a user, to a lateral side corresponding to a hip joint. While the connection element 190 is preferably rigid to a degree that it does not bend or change shape during operation, it may be bent or modified outside of normal use to better approximate a user's anatomy.

The housing or frame 198 of the enclosure 116 defines a side wall 191 forming an aperture or orifice 194 through which a first end 195 of the connection element 190 extends. A bushing 192 is received by the side wall 191 at the orifice 194, through which the first end 195 extends. A set element or screw 196 extends through the housing/frame 198 to engage and retain the first end 195 of the connection element 190 in a secure position relative to the housing/frame 198.

The housing/frame 198 defines an internal receptacle 200 dimensioned and configured to retain the first end 195 of the connection element 190 such that the first end 195 slides within the receptacle 200 when the set element 196 does not engage the connection element 190. The internal receptacle 200, therefore, permits linear adjustment along a linear axis PA1 of the connection element 190. Rotational adjustment PR is permitted about the linear axis PA1 at the first end 195 of the connection element 190 relative to the enclosure 116 to permit width regulation of the first end 195 relative to the enclosure 116. The set element 196 extends through the internal receptacle 200 to engage a surface 202 of the connection element 190 perpendicular to the linear axis PA1.

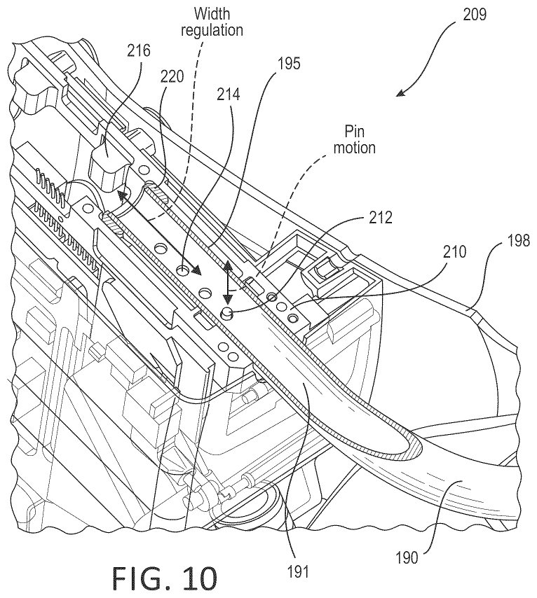

FIGS. 10-12 illustrate variations of the first adjustment mechanism 209 to regulate the position of the assistive units along the human lateral axis. The width adjustment system is designed inside the connection element housing by relying on width adjustment made discretely through a pin that enters the connection element.

Specifically, in the variations of the first adjustment mechanism 209, the connection element 190 defines a plurality of openings 214 formed along the linear axis PA1 into which a pin 212 is arranged to selectively fit in any one of the plurality of openings 214 to set the width adjustment of the first end 195 of the connection element 190 relative to the enclosure 116 in a receptacle 210 formed by the enclosure 116. The receptacle 210 defines another bushing 220 providing frictional resistance to the first end 195 of the connection element 190 and a block 216 at an end opposite to the orifice to limit the extension of the connection element 190 and corresponding width regulation. The pin 212 may be connected to a button 218 protruding from the frame 198 of the enclosure 116 and spring biased to ensure engagement of the pin 212 into one of the plurality of openings 214 and enable disengagement from one of the plurality of openings 214.

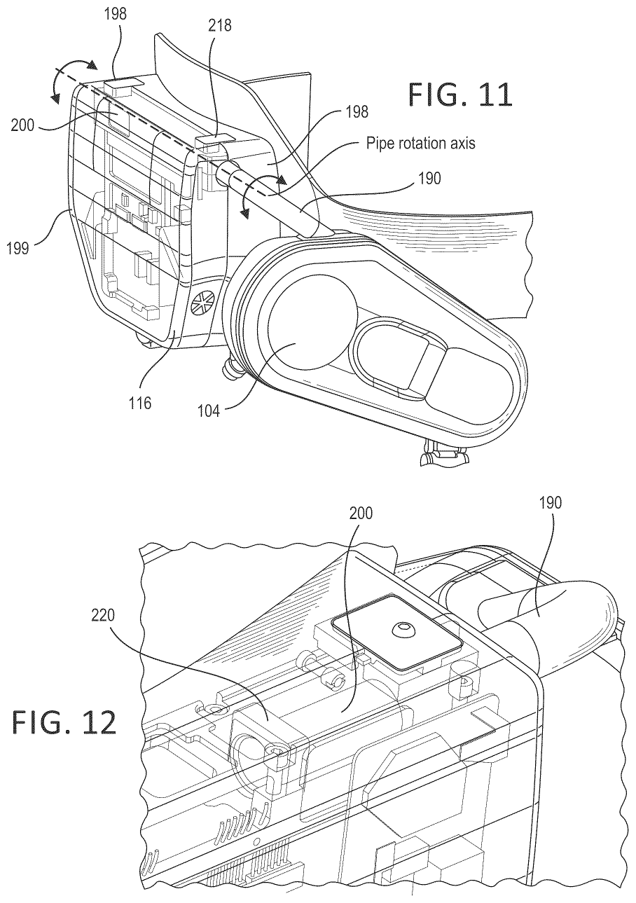

According to the embodiments in FIGS. 11 and 12, the backpack enclosure 116 can be sealed due to the use of O-ring gaskets, where the connection element enters into the housing/frame 198. Gasket cords can be provided on contact surfaces between the housing/frame 198 and a cover 199. Likewise, the electronics of the control system may be attached to the cover 199, which can facilitate assembly procedures, and increase the heat dissipation capacity using the cover as an additional surface for heat exchange. Likewise, the connection element housing 198 can be configured as a separate component concerning the housing/frame 198.

The assistive units may be fixed relative to the backpack enclosure in a different implementation, thereby removing or modifying the first adjustment mechanism. For example, the end of the connection element 190 may be welded/press fitted/glued to the bushing 220 or another component secured or retained by the housing/frame 198 that avoid the rotation of the connection element 190.

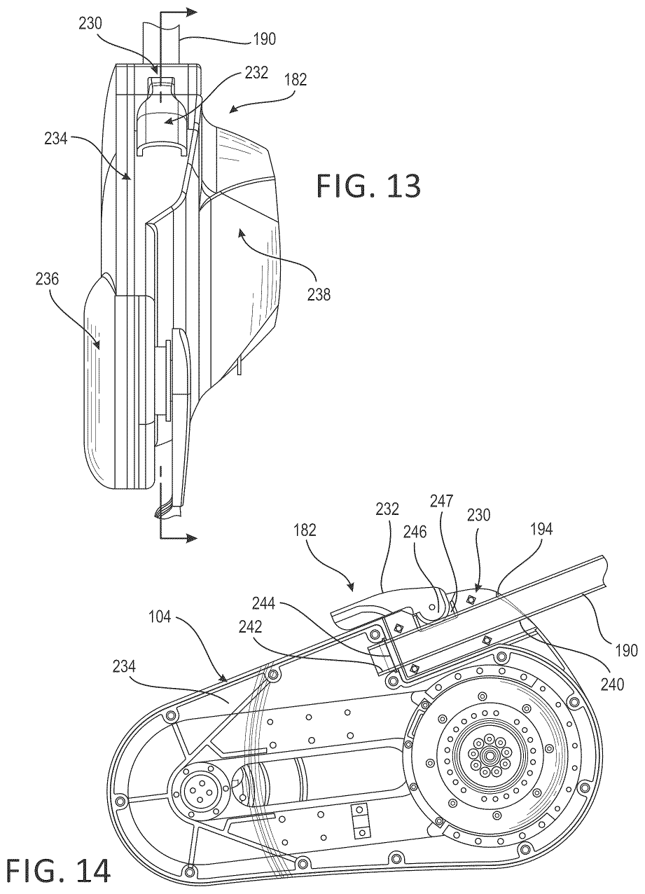

Turning to FIGS. 13 and 14, the second adjustment mechanism 182 is located on or at the assistive unit 104. From a schematic point of view, it can be represented by a prismatic joint. The second adjustment mechanism 182 aims to regulate the connection element 190, on the human sagittal plane, the relative distance between the rotation axis of the first adjustment mechanism 180 as in the preceding drawing figures and the assistive unit axis.

The second adjustment mechanism 182 includes a lever assembly 230 engaging a second end of the connection element 190, and is mounted to the assistive unit 104 to permit the second end of the connection element 190 to slidably secure to the assistive unit 104. The connection element 190 may, therefore not only slidably connect, but can rotationally mount to the second end of the connection element 190 by the lever assembly 230.

The lever assembly 230 includes a lever 232 located at least over or part of a cover assembly 236, 238 of the assistive unit 104. The cover assembly includes an outer cover 236, an inner cover 238 and a plate 234 disposed between the outer and inner covers 236, 238. The lever assembly 230 has a cam 246 extending from the lever 232, and which is engageable with a surface 202 of the connection element 190. The connection element 190 extends into a connecting block 240 carried by plate 234. The cam 246 preferably extends into an enclosure 247 defined by the connection block 240 into which the cam 246 is rotationally positioned to engage the connection element 190 selectively.

The connection block 240 defines the orifice 194 between the plate 234 and the inner cover 238, and an egress aperture 242 at an opposite end from the orifice 194 to permit extension of the second end of the connection element 190 relative to the connection block 240. The plate 234 may be sealed to the inner cover 238 by a gasket 244.

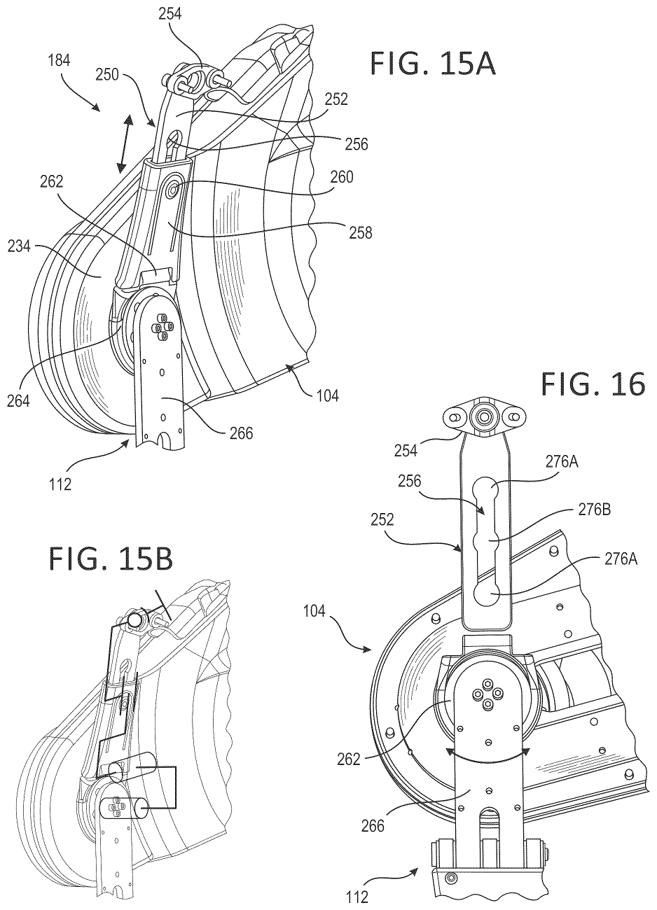

Turning to FIGS. 15A-16, the third adjustment mechanism 184 connects the assistive unit 104 to the belt system 110 (not shown; refer to FIGS. 2 and 7). The third adjustment mechanism 184 regulates a distance between the belt system and the assistive unit axis on a plane parallel to the human sagittal plane.

FIG. 15B depicts, staring from the belt side, from a schematic point of view, the third adjustment mechanism can be represented by a spherical joint in series to a prismatic joint and in series with two revolute joints with their rotation axes orthogonal to each other. Particularly, the last revolute joint has its rotational axis aligned with the assistive unit. The third adjustment mechanism may impose/constrain only the position of the prismatic joint while all other degrees of freedom passively adapt.

The third adjustment mechanism can be designed as a different combination of joints in series. For example, starting from its belt side, from a schematic point of view, the third adjustment mechanism can be represented by a prismatic joint aligned along the belt direction in series with a spherical joint, a prismatic joint, and a revolute joint orthogonal to the assistive unit axis.

Referring to FIGS. 15A and 16, the third adjustment mechanism 184 includes a slidable mechanism 250 connecting the assistive unit 104 to the belt system 110. The adjustment mechanism 250 comprises a strut 252 having a first end slidably connected to a sleeve 258 by a button 260 for selectively engaging at least one of a plurality of slots 256 formed by the strut 252. The strut 252 may have a second end connected to a bracket 254 securable to the belt assembly, and the sleeve 258 may be secured to the assistive unit 104.

The bracket 254 is pivotally or fixedly secured to the belt assembly. The sleeve (258) is pivotally or fixedly secured to the assistive unit. The sleeve 258 may be fixedly secured to an inner plate 234 of the assistive unit 104 near or at the second end thereof. The strut 252 defines an elongate slot 256 having at least two notches 276A-276C defined along a length thereof in which the button can selectively engage.

In a variation of the third adjustment mechanism to increase the stability of the abovementioned solution, the third adjustment mechanism can be an adjustable fabric strap attached to the belt and to the assistive unit with the possibility to rotate with respect to them freely. Alternatively, the third adjustment mechanism may be removed, resulting in a parallel plan of the sagittal plan, the revolute joint of the first adjustment mechanism may be directly in charge of the orientation of the assistive unit.

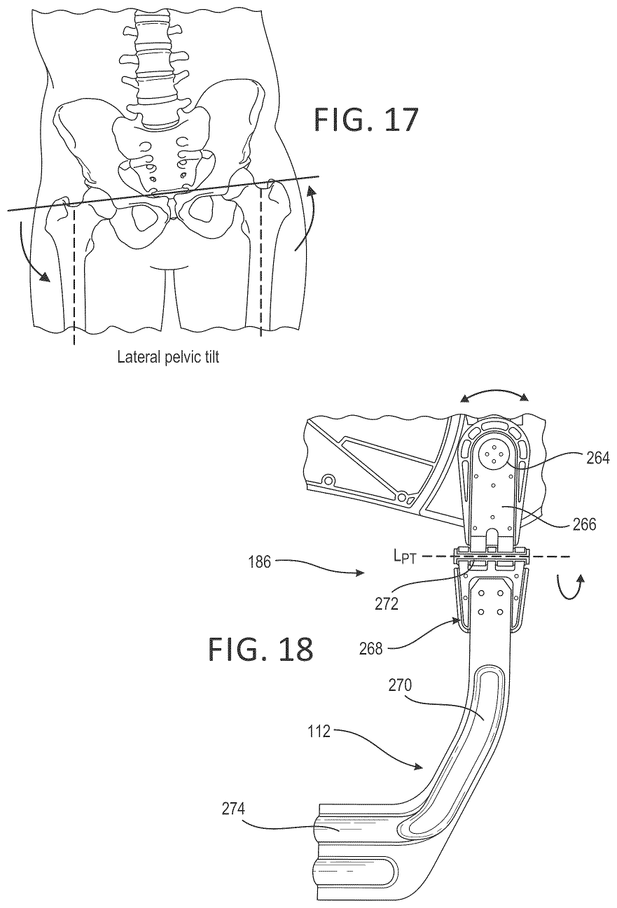

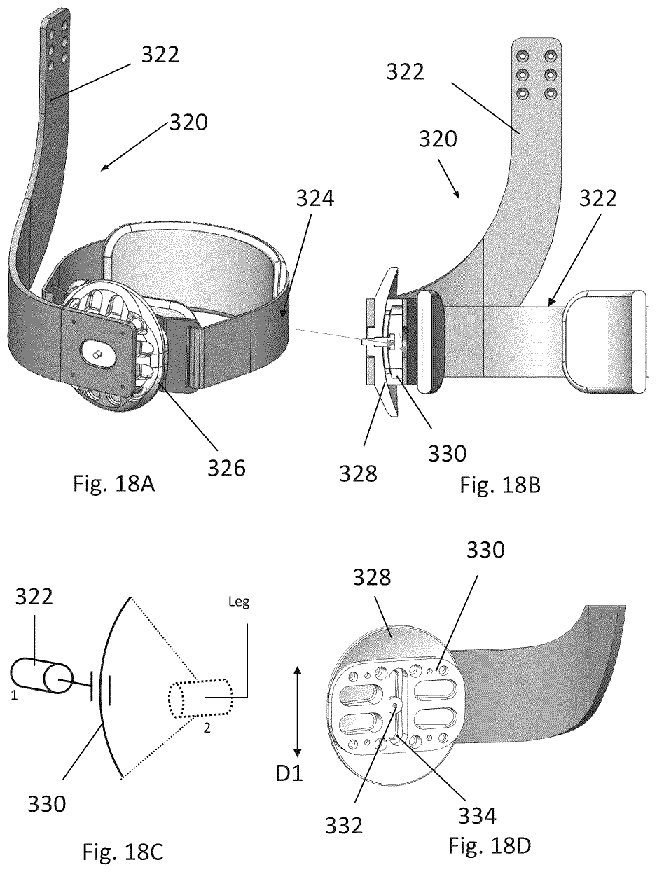

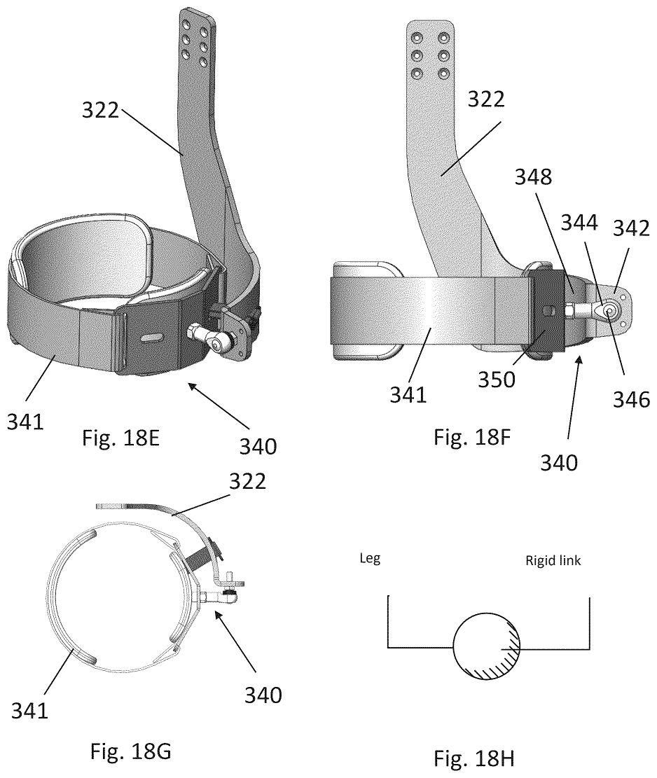

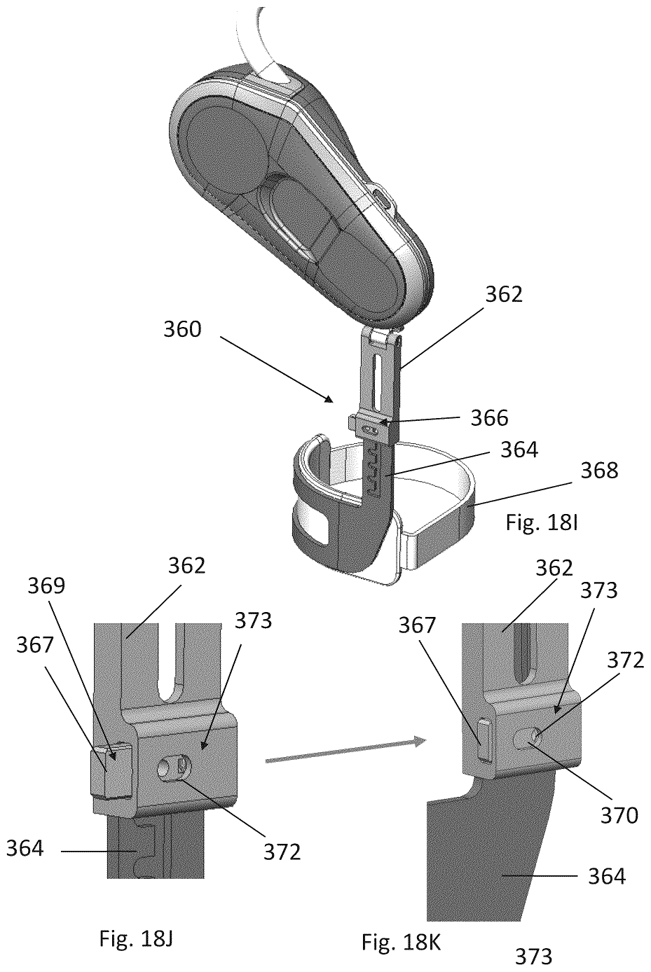

FIG. 18 shows the fourth adjustment mechanism 186 and corresponding thigh link assembly 112. The thigh link assembly 112 comprises the first link segment 266 pivotally connected to the assistive unit 104, a second link segment 268 hingedly attached to the first link segment 266 by a hinge 272 having a lateral pelvic tilt axis LPT. FIG. 17 exemplifies how pelvic tilt movements occur. A thigh extension strut 270 has a first end connecting to the second link segment 268 and a second end from which a thigh cuff 274 extends and is adapted to extend about the circumference of a user's leg.

The first and second link segments connected by hinge are allowed to rotate relatively freely. Such a passive degree of freedom has been designed to account for users'different leg shapes passively, and lateral pelvic tilt movements, as shown in FIG. 17.

In a different implementation, the passive degree of freedom of the thigh link may be removed. Alternatively, screws may couple the thigh link assembly with the assistive unit. An interference fit can connect the thigh link assembly to the assistive unit in a different implementation. The second link segment 268 may be made of carbon fiber or aluminum to reduce weight. To reduce friction among components, plastic bushings or bearings may be used.

While the thigh cuffs are described as being rigidly connected to the second link segment, a variation may allow for a connection to be arranged so that a passive rotation of the thigh cuff occurs along an axis parallel to the hip flexion-extension axis, or an adjustable linear sliding of the thigh cuff along the main direction of the thigh link segments. In an embodiment, the thigh link has a first link segment 266 secured to the assistive unit 104 at a swivel 264, whereat the sleeve 258 secures. The thigh link assembly 112 attaches to the assistive unit 104 at hinge 262 that allows for rotational movement at the hip flexion-extension axis.

FIGS. 18A-18D exemplify a variation of the thigh link assembly 320. A thigh extension strut 322 connects to the thigh cuff 324, including a strap 326, adapted to extend about the thigh of the user. The thigh cuff 324 includes first and second components 328, 330.

The thigh cuff 324 involves the implementation of a passive Degree of Freedom at the level of thigh cuff improves the self-adaptability of this latter with the user's thigh both during the donning procedure and moreover along the leg range of motion explored by the user while walking or performing other movements involving hip flexion extension. The self-adaptability of the thigh cuff compensates for possible misalignments between the robotic and human hip joints that could cause, in case of a non-adaptable thigh cuff, non-perfect matching between the thigh and cuff surfaces, with consequent non comfortable interaction between the user and the robot.

As FIGS. 18A-18C illustrate shows, the thigh cuff 324 is connected to the thigh extension strut 322 by the first component 328 and the second component 330. The second component 330 rotates on a spherical pin surface 332 of the first component 328. The second component 330 is forced, by a slot 334 formed by the second component 330, to travel in direction D1.

Referring to FIGS. 18C and 18D, the thigh cuff 324, as provided by the first and second components 328, 330, permit the rotation of the thigh cuff 324 along an axis perpendicular to the user's hip flexion-extension to obtain a free adjustment of the force application point regarding a user's thigh width. The thigh cuff 324 is also arranged to rotate about a remote axis parallel to the user's hip flexion-extension to guarantee the comfort in case of misalignment.

FIGS. 18E-18H illustrate another variation of the thigh link assembly 340. A spherical joint 342 connects the thigh cuff 341 e.g., strap, to the thigh extension strut 322. The spherical joint includes a mount 344 including the ball 346 connecting a rod 348 to a bracket 350 connecting to the thigh cuff 341.

FIG. 18I illustrates a length adjustment mechanism 366 arranged for adjusting the length of a thigh extension strut 360. The length adjustment mechanism 366 permits adjustable linear sliding to enable a selection of the correct position of the thigh cuff 341 with respect to different anthropometries. The thigh extension strut 360 has a first segment 362 and a second segment 364 arranged to slide relative to. Preferably, as shown, the second segment 364 slides within the first segment 362 and is lockable in relative location therewith by the adjustment mechanism 366, arranged to lock and unlock the second segment 364 relative to the first segment 362.

FIGS. 18J and 18K schematically show the length adjustment mechanism 366 as having a button 368 that is spring biased so a protruding element 370 engages an aperture 372 to lock the first and second segments 362, 364. A carriage 369 carries the button 368 and the protruding element 370 slides linearly in a housing 373 forming the button 367. FIG. 18J illustrates a locked configuration and FIG. 18K illustrates an unlocked configuration.

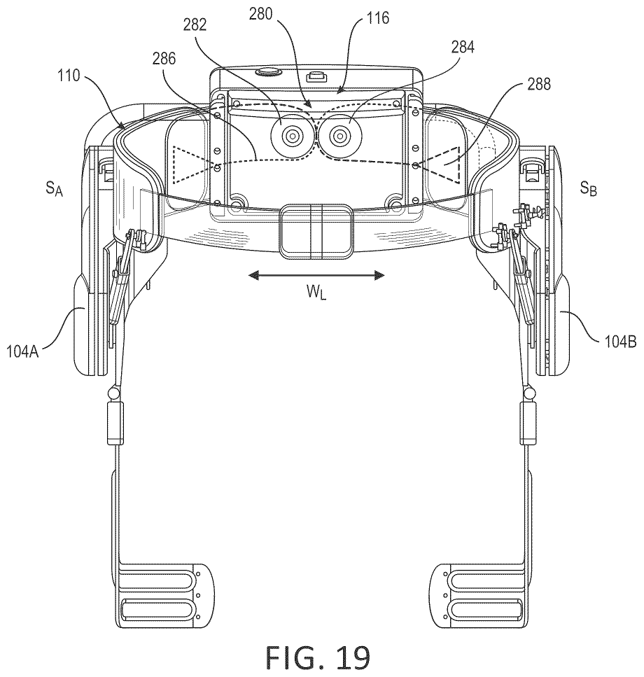

FIG. 19 depicts an alternative system to regulate the position of the assistive units 104A, 104B along the human lateral axis. Once the exoskeleton is worn, the user can bring the actuation units closer to him by pulling the cords 286, 288 attached to them. The cords pass through a system of pulleys 282, 284 provided at the backpack enclosure 116. When the assistive units are positioned, the cords 286, 288 can be attached to the belt by any of the aforementioned fasteners. A lumbar adjustment mechanism 280 comprises the system of pulleys 282, 284 for adjusting a lumbar width (WL) of the assistive devices units 104A, 104B relative to one another.

The features and/or components of one embodiment, example, or figure discussed, shown, or suggested hereinabove may be combined with features and/or components of other embodiments, examples, or figures discussed, shown, or suggested herein to provide embodiments, examples, or implementation variations that are not explicitly verbally or visually described or shown herein.

It is to be understood that even though numerous characteristics and advantages of various embodiments of the present disclosure have been outlined in the foregoing description, together with details of the structure and function of various embodiments thereof, this detailed description is illustrative only, and changes may be made in detail, especially in matters of structure and arrangements of parts within the principles of the present disclosure to the full extent indicated by the broad general meaning of the terms in which the appended claims are expressed.

1.-28. (canceled)

29. A pelvis orthosis comprising:
a physical Human-Robot interface comprising a belt system;
at least one assistive unit corresponding to a user's hip flexion-extension axis, the at least one assistive unit adjustably connected to the belt system by a coupling assembly;
wherein the coupling assembly is arranged to rotatably adjust or linearly adjust the at least one assistive unit relative to the belt system.

30. The pelvis orthosis of claim 29, wherein the at least one assistive unit is adjustably secured to the belt system by a linkage.

31. The pelvis orthosis of claim 30, further comprising a shoulder strap system removably securable to the belt system.

32. The pelvis orthosis of claim 31, wherein the shoulder strap system includes straps arranged to extend around a user's shoulders, the shoulder strap system having anterior and posterior links configured to couple to anterior and posterior straps connected to the belt system.

33. The pelvis orthosis of claim 29, wherein the coupling assembly is received by a first end of the at least one assistive unit, and a link assembly extends from a second end of the at least one assistive unit opposite the first end.

34. The pelvis orthosis of claim 29, wherein the belt system is arranged to circumferentially extend about a user;
wherein the belt system defines a rigid structure including a posterior, central component and first and second lateral components extending from opposed sides of the central component;
wherein the belt system defines first and second buckle parts arranged to couple to one another and flexibly extending from the first and second lateral components;
wherein the belt system further includes at least a central pad configured to attach and correspond to the central component, or first and second lateral component pads configured to attach and correspond to the first and second lateral components.

35. The pelvis orthosis of claim 29, wherein the at least one assistive unit is connected to an electronic or control system by a first adjustment mechanism arranged to regulate a position of the assistive unit along a human lateral axis, and passively follows an orientation of the assistive unit, wherein the first adjustment mechanism comprises a revolute joint relative to a lumbar region of the pelvis orthosis.

36. The pelvis orthosis of claim 29, wherein the at least one assistive unit has a first end that is linearly adjustable relative to an electronic or control system by a second adjustment mechanism;
wherein the at least one assistive unit has a second end that is at least linearly and/or rotationally adjustable to the belt system by a third adjustment mechanism.

37. The pelvis orthosis of claim 29, further comprising a thigh link assembly adjustably secured to the at least one assistive unit and adapted to secure to a user's thigh.

38. The pelvis orthosis of claim 37, wherein the thigh link is rotationally secured to a second end of the at least one assistive unit, and a second segment of the thigh link is hingedly connected by a hinge to a first segment of the thigh link;
wherein a thigh extension strut has a first end connecting to the second link segment and a second end from which a thigh cuff extends and is adapted to extend about a circumference of a user's leg.

39. The pelvis orthosis of claim 29, wherein the coupling assembly is defined as a connection element for connecting the assistive unit to a backpack enclosure of the physical Human-Robot interface, the connection element having a generally perpendicular bend between first and second ends of the connection element, such that the bend is in a range of 75 to 100 degrees to reorient the assistive unit relative to the backpack enclosure arranged to correspond to a lumbar and posterior region on a user, to a lateral side corresponding to a hip joint.

40. The pelvis orthosis of claim 39, wherein the connection element defines a plurality of openings formed along a linear axis (PA1) into which a pin is arranged to selectively fit in any one of the plurality of openings to set a width adjustment of the first end of the connection element relative to the enclosure in a receptacle formed by the enclosure, the receptacle defining another bushing providing frictional resistance to the first end of the connection element and a block at an end opposite to an orifice to limit extension of the connection element and corresponding width regulation, the pin is arranged to be connected to a button protruding from a frame of the enclosure and spring biased to ensure engagement of the pin into one of the plurality of openings and enable disengagement from one of the plurality of openings.

41. The pelvis orthosis of claim 39, further comprising a lever assembly engaging a second end of the connection element and mounted to assistive unit to permit the second end of the connection element to slidably secure to the assistive unit, the connection element is arranged to rotationally mount to the second end of the connection element by the lever assembly.

42. The pelvis orthosis of claim 41, wherein the lever assembly includes a lever located at least over a cover assembly of the assistive unit, the cover assembly including an outer cover, an inner cover and a plate disposed between the outer and inner covers.

43. The pelvis orthosis of claim 42, wherein the lever assembly includes a cam extending from the lever and engageable with the connection element, the connection element extending into a connecting block carried by plate and the cam extending into an enclosure defined by the connection block into which the cam is rotationally positioned to selectively engage the connection element. (New) The pelvis orthosis of claim 43, wherein the connection block defines an orifice between the plate and the inner cover, and an egress orifice at an opposite end from the orifice to permit extension of the second end of the connection element relative to the connection block.

45. The pelvis orthosis of claim 39, wherein further comprising an electronic or control system encased by a backpack enclosure of the physical Human-Robot interface to which the coupling assembly is adjustably secured;
wherein the electronic or control system is carried at a lumbar region of the belt system.

46. The pelvis orthosis of claim 45, wherein a frame of the enclosure defines a side wall forming an orifice through which a first end of the connection element extends, a bushing is received by the side wall at the orifice and through which the first end extends, a set element extends through the frame to engage and retain the first end of the connection element in a secure position relative to the frame.

47. The pelvis orthosis of claim 46, wherein the frame defines an internal receptacle dimensioned and configured to retain the first end of the connection element such that the first end slides within the receptacle when the set element does not engage the connection element, the internal receptacle is arranged to permit linear adjustment along a linear axis (PA1) of the connection element, and rotational adjustment about the linear axis (PA1) at the first end of the connection element relative to the enclosure to permit width regulation of the first end relative to the enclosure, the set element extending through the internal receptacle to engage a surface of the connection element and perpendicular to the linear axis (PA1).

48. The pelvis orthosis of claim 29, comprising a slidable adjustment mechanism connecting the assistive unit to the belt system, the adjustment mechanism including a strut having a first end slidably connected to a sleeve by a button selectively engaging at least one of a plurality of slots formed by the strut, and the strut having a second end connected to a bracket securable to the belt system, the sleeve secured to the assistive unit.
